(19) United States
(12) Patent Application Publication
(10) Pub. No.: US 2020/0320409 A1
(43) Pub. Date: Oct. 8, 2020

(54) MODEL CREATION SUPPORTING METHOD AND MODEL CREATION SUPPORTING SYSTEM

(71) Applicant: Hitachi, Ltd., Tokyo (JP)

(72) Inventors: Kazuhide Aikoh, Tokyo (JP); Eri Teruya, Tokyo (JP)

(73) Assignee: Hitachi, Ltd., Tokyo (JP)

(21) Appl. No.: 16/823,562

(22) Filed: Mar. 19, 2020

(30) Foreign Application Priority Data
Apr. 5, 2019 (JP) 2019-072538

(51) Int. Cl. G06N 5/04; G06N 20/00; G06K 9/62; G06F 17/18

(52) U.S. Cl. CPC G06N 5/04; G06N 20/00; G06F 17/18; G06K 9/6256; G06K 9/6215; G06K 9/6263

(57) ABSTRACT

A model creation supporting system executes: learning processing to create an inference model by performing machine learning on pieces of training data so as to specify a feature of each piece of the data, the inference model being designed to infer a label to be set to a piece of input data based on a feature of the piece of input data; and evaluation processing to determine validity of inference of the label in accordance with the inference model by determining a similarity between a feature of a given piece of data specified by inputting the given piece of data to the created inference model and the feature of one of the pieces of training data specified by the machine learning, and to output information indicating a content of the determination.

### CROSS-REFERENCE TO RELATED APPLICATION

This application claims priority pursuant to 35 U.S.C. § 119 from Japanese Patent Application No. 2019-072538, filed on Apr. 5, 2019, the contents of which is incorporated herein by reference in its entirety.

### BACKGROUND

### Technical Field

The present invention relates to a model creation supporting method and a model creation supporting system.

### Background Art

For an improvement in accuracy of an analysis model (an inference model) that applies a machine learning method, selection of training data and tuning of analytical parameters for the analysis model are important factors. Nonetheless, in a case where desired analytical accuracy is not achieved, it is uncertain whether the training data have problems or the analytical parameters have problems.

In this regard, a method of automatically adding unsupervised data to supervised data when the unsupervised data succeeds in inference of a “correct answer” at high reliability based on a learned model (Japanese Patent Application Publication No. 2005-92253: PTL 1) and a method of presenting a rule that has an effect on a determination result (Japanese Patent Application Publication No. 2017-58816: PTL 2) have been known as techniques for supporting an improvement in precision of an analysis model.

Nevertheless, a large improvement in precision cannot be expected from the technique disclosed in PTL 1 even through the data inferred at high probability by the learned model that already exists is added to the training data. On the other hand, the technique disclosed in PTL 2 requires an individual to input information extraction rules (features) from sentences by hand to a system. Here, the information contained in the sentences is enormous and an individual has a practical limit on determination of such extraction rules that are supposed to be inputted.

### SUMMARY

The present invention has been made in view of the aforementioned circumstances. An object of the invention is to provide a model creation supporting method and a model supporting creation system, which are capable of reliably improving precision of a model created by machine learning.

According to an aspect of the present invention to attain the object, a model creation supporting system provided with a processor and a memory executes: learning processing to create an inference model by performing machine learning on a plurality of pieces of training data so as to specify a feature of each piece of the data, the inference model being designed to infer a label to be set to a piece of input data based on a feature of the piece of input data; and evaluation processing to determine validity of inference of the label in accordance with the inference model by determining a similarity between a feature of a given piece of data specified by inputting the given piece of data to the created inference model and the feature of one of the pieces of training data specified by the machine learning, and to output information indicating a content of the determination.

According to the present invention, it is possible to reliably improve accuracy of a model created by machine learning.

### BRIEF DESCRIPTION OF THE DRAWINGS

FIG. 1 is a diagram showing an example of a configuration of a document analysis system 100 (a model creation supporting system) according to an embodiment of the present invention.

FIG. 2 is a diagram showing an example of a configuration provided to an analysis node 2.

FIG. 3 is a diagram showing an example of a data format of document data 2121.

FIG. 4 is a diagram showing an example of supervised dictionary data 2122.

FIG. 5 is a diagram showing an example of an inference model parameter 2123.

FIG. 6 is a diagram showing an example of inference result data 2124.

FIG. 7 is a diagram showing an example of check label extraction rule 2126.

FIG. 8 is a diagram showing an example of feature difference data 2125.

FIG. 9 is a diagram showing an example of check label data 2127.

FIG. 10 is a flowchart to explain an example of document analysis processing.

FIG. 11 is a flowchart to explain an example of learning processing.

FIG. 12 is a flowchart to explain details of evaluation processing.

FIG. 13 is a flowchart to explain details of feature difference extraction processing.

FIG. 14 is a flowchart to explain details of check label extraction processing.

FIG. 15 is a diagram showing an example of a check label suggestion screen.

FIG. 16 is a flowchart to explain details of inference processing.

### DETAILED DESCRIPTION OF EMBODIMENTS

A model creation supporting system according to an embodiment of the present invention will be described below with reference to the accompanying drawings. While the following description may include expressions such as “X×X table” in order to express certain pieces of information, these pieces of information may also apply an expression of a data structure other than that based on the table. In this context, the expressions “X×X table” and the like may also be referred to as “XXX information” in order to clarify that the information does not necessarily rely on the data structure. In a case of describing contents of information of a certain type, identification information using an expression such as “number” and “name” may be adopted. However, other types of identification information may be used instead. An expression “XXX processing” in the following description may also be interpreted as an “XXX program” instead. In the following description, an explanation that has “processing” as its subject may also be interpreted as an explanation that has a processor as its subject. All or part of the processing may be implemented in dedicated hardware. Various programs may be installed on each computer via a program distribution server or a computer-readable storage medium.

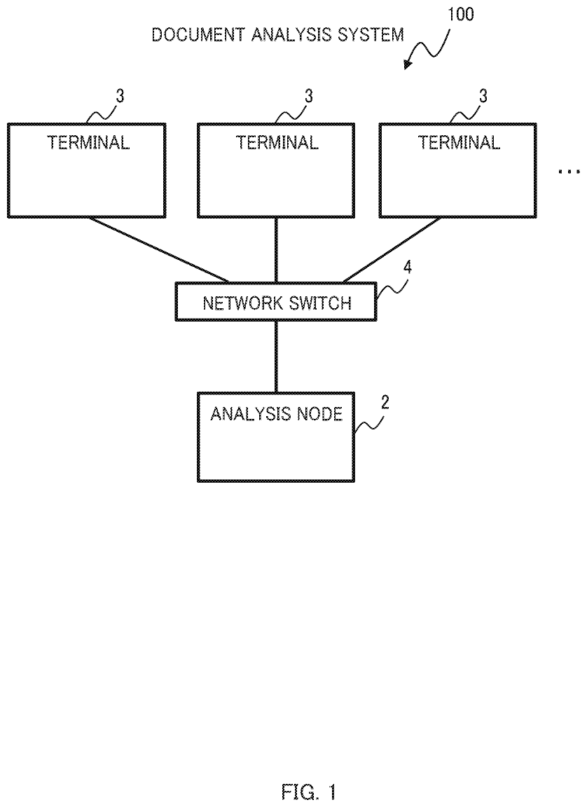

FIG. 1 is a diagram showing an example of a configuration of a document analysis system 100 (a model creation supporting system) according to this embodiment. The document analysis system 100 creates an inference model for inferring semantic contents of words in document data for training by performing machine learning to infer the contents of the respective words, thereby analyzing semantic contents of document data for inference designated by a user. The document analysis system 100 is installed in a prescribed datacenter, for example. The document analysis system 100 includes terminals 3 each holding document data for inference data, and an analysis node 2 that creates an inference model and infers the document data for inference transmitted from each terminal 3 in accordance with the inference model. Here, the analysis node 2 and each of the terminals 3 are coupled to each other through a network switch 4. For example, the analysis node 2 and each of the terminals 3 are communicably coupled to each other by using the network switch 4 located in between, and through a wired or wireless communication network such as a local area network (LAN), a wide area network (WAN), the Internet, and an exclusive line.

Each of the analysis node 2 and the terminals 3 is constructed by using a personal computer, a workstation, or the like.

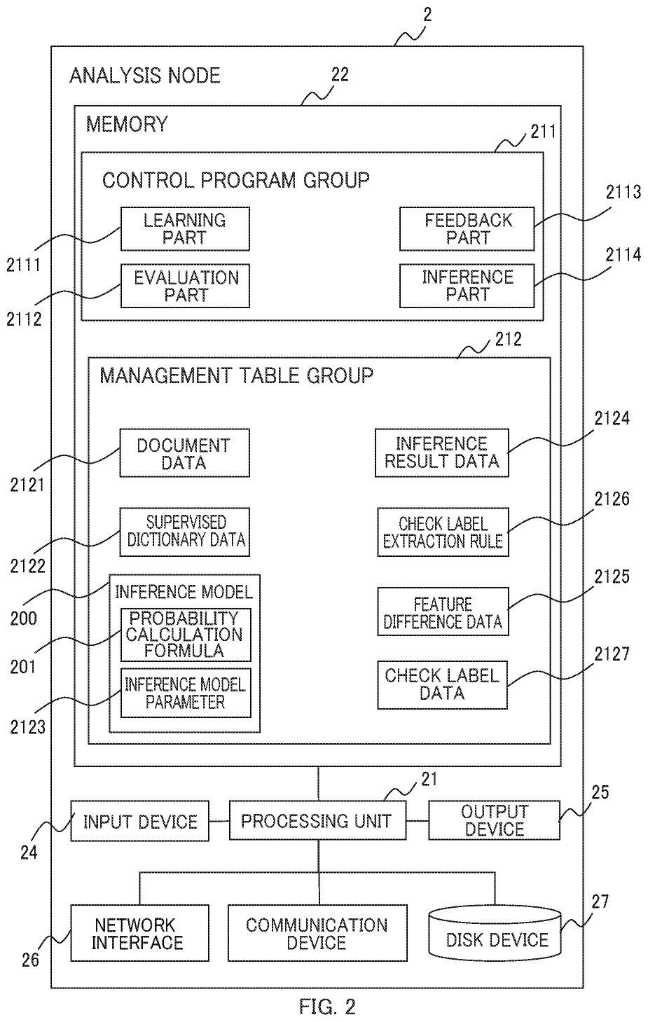

FIG. 2 is a diagram showing an example of a configuration provided to the analysis node 2. The analysis node 2 includes a processing unit 21 such as a central processing unit (CPU), a memory 22 such as a random access memory (RAM) and a read only memory (ROM), a disk device 27 such as a Fibre Channel (FC) disk, a Small Computer System Interface (SCSI) disk, a SATA disk, an AT attachment (ATA) disk, and a Serial Attached SCSI (SAS) disk, an input device 24 formed from a keyboard, a mouse, a touch panel, and the like, an output device 25 formed from a monitor (a display) and the like, and a communication device 26 that communicates with another apparatus. Here, the processing unit 21 governs the operation control of the entire analysis node 2 and executes required processing based on a control program group 211 and a management table group 212 to be described later, which are stored in the memory 22. Besides the storage of the control program group 211 and the management table group 212 to be described later, the memory 22 is also used as a work memory for the processing unit 21. The communication device 26 is a communication interface compatible with the network switch 4 and conducts protocol control when the analysis node 2 performs communication.

The analysis node 2 is equipped with functions including a learning part 2111, an evaluation part 2112, a feedback part 2113, and an inference part 2114 collectively as the control program group 211. Moreover, the analysis node 2 stores document data 2121, supervised dictionary data 2122, an inference model 200, inference result data 2124, a check label extraction rule 2126, feature difference data 2125, and check label data 2127.

The learning part 2111 accepts a given learning processing request from one of the terminals 3.

The learning part 2111 creates the inference model 200, which is designed to infer a label to be set to a piece of input data based on a feature of the piece of input data, by performing machine learning on pieces of document data for training so as to specify a feature of each piece of the document data for training.

Specifically, the learning part 2111 performs the machine learning to specify a weight value of a feature, thus creating the inference model 200 used to infer the label to be set to the input data based on the weight value of the feature of the input data. Note that the label is assumed to be a personal name label in this embodiment, which is to be set to a word determined to be a personal name.

The inference model 200 includes a probability calculation formula 201 used to calculate a probability to be described below, and an inference model parameter 2123 which is a parameter group used in the inference model 200.

The inference model 200 infers the label from the feature of the input data based on the probability serving as a parameter for determining the type of the label to be set to the input data. Note that the information on the label thus inferred is stored in the check label data 2127 to be described later.

Here, the learning part 2111 stores the document data for training and the document data for inference data in the document data 2121. Moreover, the learning part 2111 stores words extracted by the machine learning from the document data recorded in the document data 2121 and labels set to the words in the supervised dictionary data 2122 collectively as dictionary data.

Now, examples of the document data 2121 and the supervised dictionary data 2122 will be described.

<Document Data>

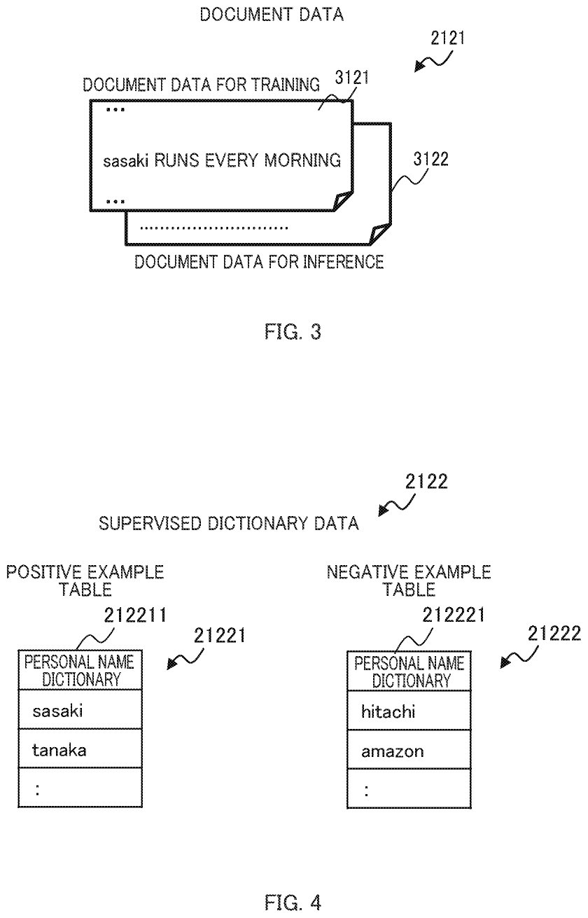

FIG. 3 is a diagram showing an example of a data format of the document data 2121. The document data 2121 includes document data for training 3121 that records the document data for training and document data for inference 3122 that records the analysis target data. Each piece of the document data for training 3121 and the document data for inference 3122 includes one or more pieces of document data. In the example of FIG. 3, a sentence that reads “Mr. sasaki runs every morning” is recorded in the document data for training 3121. The document data for training 3121 is news article data, for example, and contains words that represent personal names in the article.

<Supervised Dictionary Data>

FIG. 4 is a diagram showing an example of the supervised dictionary data 2122. The supervised dictionary data 2122 includes a positive example table 21221 and a negative example table 21222.

The positive example table 21221 includes an item of a personal name dictionary column 212211 that stores words each determined to be a personal name (hereinafter referred to as positive examples). Meanwhile, the negative example table 21222 includes an item of a personal name dictionary column 212221 that stores words each determined not to be a personal name (hereinafter referred to as negative examples). In the example of FIG. 4, words “sasaki” and “tanaka” are registered as the words determined to be the positive examples while words “hitachi” and “amazon” are registered as the words determined not to be the negative examples.

Next, the inference model parameter 2123 will be described in detail.

<Inference Model Parameter>

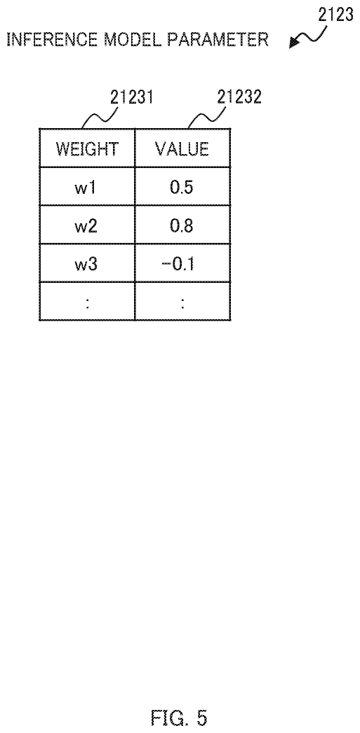

FIG. 5 is a diagram showing an example of the inference model parameter 2123. The inference model parameter 2123 includes a weight column 21231 that stores variable names each representing a weight value, and a value column 21232 that stores values (weight values) of variables relevant to the weight column 21231.

<Probability Calculation Formula>

Next, the probability calculation formula 201 will be described. The probability calculation formula 201 is a formula expressed by the features and the weight values thereof. In this embodiment, the probability calculation formula 201 is defined as:

P=w1*X1+w2*X2+w3*X3.

Here, P denotes a probability, w denotes the weight value, and X denotes the feature. In this case, the weight w1 of the feature X1 is 0.5, the weight w2 of the feature X2 is 0.8, and the weight w3 of the feature X3 is −0.1.

In this embodiment, when the probability P of a certain analysis target word is equal to or above a first threshold (which is set to 0.85 in this embodiment), a value “T” is set to the label of this word (representing that the word is highly likely to be a personal name for the reason of having a large amount of the positive feature, for example). Meanwhile, when the probability P of a certain word is equal to or above a second threshold (which is set to 0.25 in this embodiment) but below the first threshold, a value “Null” is set to the label of this word (representing that it is uncertain whether or not the word is a personal name for the reason of having the positive and negative feature quantities, for example). In the meantime, when the probability P of a certain word is below the second threshold, a value “F” is set to the label of this word (representing that the word is unlikely to be a personal name for the reason of having a large amount of the negative feature, for example).

In the following, a range of the probability P where the value “T” is set will be defined as a first region, a range of the probability P where the value “Null” is set will be defined as a second region, and a range of the probability P where the value “F” is set will be defined as a third region.

Here, the learning part 2111 records data on a result of creation of the inference model 200 and data obtained at the time of creation of the inference model 200 in the inference result data 2124.

Now, an example of the inference result data 2124 will be described.

<Inference Result Data>

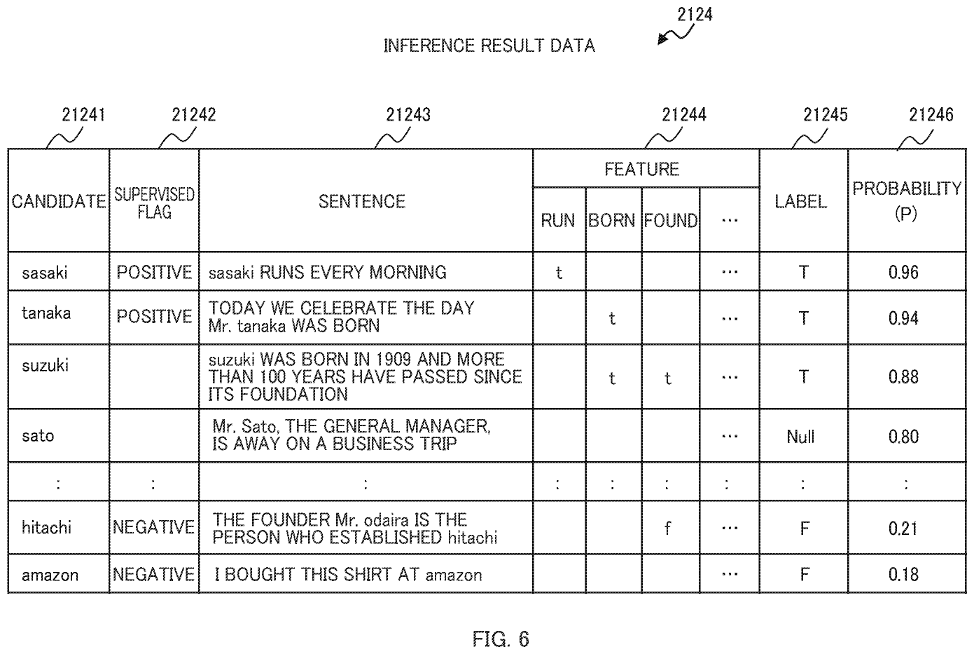

FIG. 6 is a diagram showing an example of the inference result data 2124. The inference result data 2124 includes a candidate column 21241 that stores learned or analyzed words (note that the inference result data 2124 stores not only the word in the document data for trainings but also results of input of the inference model 200 to the words in analysis target sentences), a supervised flag column 21242 that stores information indicating whether each word relevant to the candidate column 21241 represents the positive example (“positive”) or the negative example (“negative”), a sentence column 21243 that stores sentences (the document data for training 3121) that register the words relevant to the candidate column 21241, a feature column 21244 that stores information on the feature quantities of the words (in which “t” represents a positive feature and “f” represents a negative feature, for example) relevant to the candidate column 21241, a label column 21245 that stores information on labels set to the words relevant to the candidate column 21241, and a probability column 21246 that stores the probabilities P of the words relevant to the candidate column 21241.

The feature column 21244 stores the feature quantities relevant to the words existing in the sentences relevant to the sentence column 21243 out of the feature quantities provided to the words relevant to the candidate column 21241. Specifically, a word that exists in a sentence relevant to the sentence column 21243 is registered (as “t”) with a corresponding item on a list of feature quantities in the feature column 21244, for example.

Meanwhile, in this embodiment, any of the values “T”, “F”, and “Null” is set to each item in the label column 21245. In the example in FIG. 6, the word “sasaki” is a piece of the document data for training which represents the positive example (“positive”). This word is recorded in the sentence (the document data for training 3121) that reads “Mr. sasaki runs every morning” and this sentence includes the positive feature attributed to the element “run”. As a consequence, this word “sasaki” has the probability P with the value “0.96” being larger than the first threshold. Therefore, the label “T” that indicates a high probability of being a personal name is set to this word.

Next, the evaluation part 2112 shown in FIG. 2 accepts a given processing request from one of the terminals 3.

Then, the evaluation part 2112 determines similarity between a feature of a given piece of data (which may either be a word in the document data for training or a new additional word in the document data for inference) that is specified by inputting the given piece of the data to the inference model 200 created by the learning part 2111 and the feature of the piece of the document data for training that has been already specified by the machine learning with the learning part 2111. Thus, the evaluation part 2112 determines validity of inference of the label in accordance with the inference model 200 and outputs information indicating a content of the determination. Here, the evaluation part 2112 stores the information on the similarity between the feature quantities in the feature difference data 2125. Meanwhile, the evaluation part 2112 stores a result of determination of the validity of setting of the label in the check label data 2127.

To be more precise, the evaluation part 2112 sets up multiple determination rules applicable to the determination of similarity between the features depending on the probability, and determines the validity of inference of the label in accordance with the inference model 200 based on the determination rules thus set up. Note that the evaluation part 2112 stores the determination rules in the check label extraction rule 2126 to be described later.

In addition, the evaluation part 2112 determines the similarity between the feature of the given piece of the data and the feature of the piece of the document data for training by specifying a feature possessed by both pieces of the data in common (hereinafter referred to as an overlapping feature) and a feature possessed only by one of the pieces of the data (hereinafter referred to as a differential feature), thereby determining the validity of inference of the label.

Furthermore, the evaluation part 2112 determines a similarity between the weight value of the feature of the given piece of the data and the weight value of the feature of the piece of the document data for training. Thus, the evaluation part 2112 determines validity of the weight values in the inference model 200. Here, the overlapping feature and the differential feature are stored in the feature difference data 2125 to be described later.

Now, specific examples of the check label extraction rule 2126 and the feature difference data 2125 will be described, respectively.

<Check Label Extraction Rule>

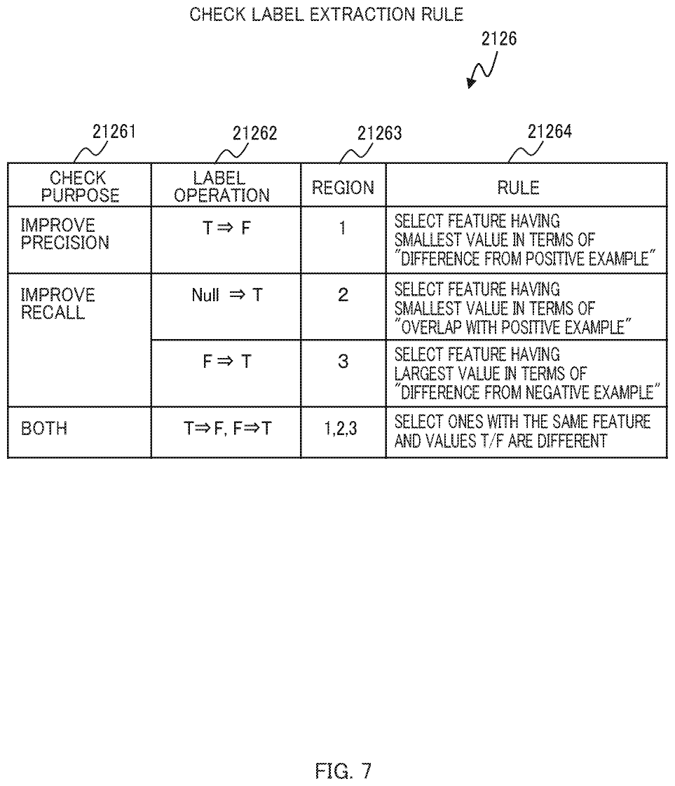

FIG. 7 is a diagram showing an example of the check label extraction rule 2126. The check label extraction rule 2126 is the information storing the determination rules, and includes a check purpose column 21261 that stores information indicating purposes to change the labels, a label operation column 21262 that stores information to specify contents of changes of the labels (label operations), a region column 21263 that stores information to specify the regions to which the words subject to change of the labels belong, and a rule column 21264 that stores determination rules as items, respectively.

The check label extraction rule 2126 stores a determination rule (a first determination rule) for improving accuracy of each label, which is applied to each word having the probability P that belongs to the first region. Moreover, the check label extraction rule 2126 stores a determination rule (a second determination rule) for improving recall, which is applied to each word having the probability P that belongs to the second region. Furthermore, the check label extraction rule 2126 stores a determination rule (a third determination rule) for improving the recall, which is applied to each word having the probability P that belongs to the third region. In addition, the check label extraction rule 2126 stores a determination rule (a fourth determination rule) for improving precision and the recall, which is applied to every word.

For example, the purpose of the first determination rule is to “improve precision”, that is, to discover a word that does not represent a personal name but is provided with the label by mistake. In this case, the first determination rule is defined as “T→F”. To be more precise, if a certain word is provided with the label (T) by mistake, the label is changed such that no label is provided to that word (F). The first determination rule targets at the words in the region “1”.

Now, the feature difference data will be described.

<Feature Difference Data>

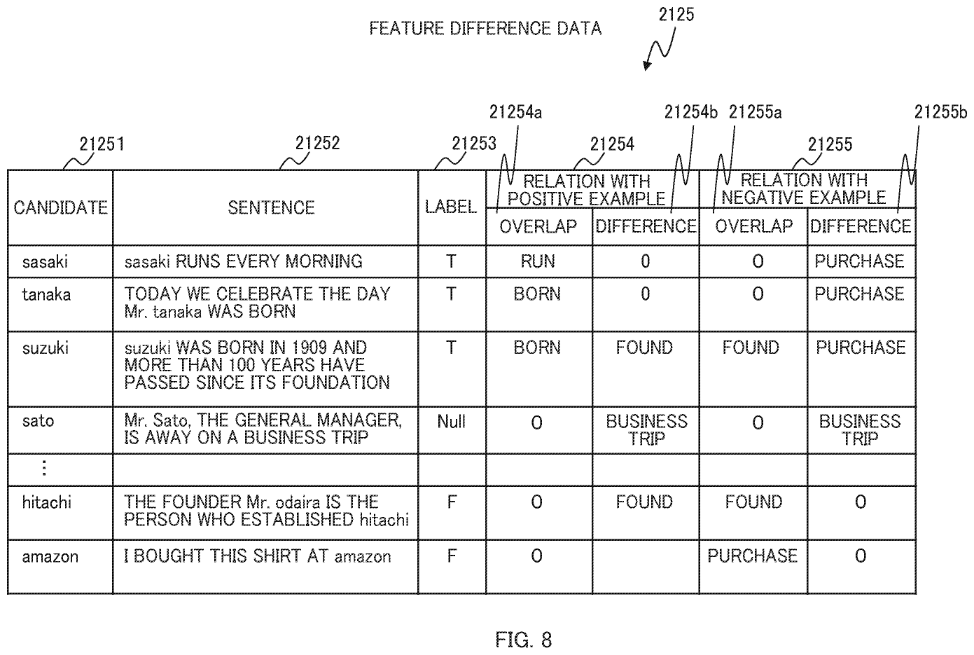

FIG. 8 is a diagram showing an example of the feature difference data 2125. The feature difference data 2125 includes items of a candidate column 21251 that stores the words in the document data for training or the analysis target words, a sentence column 21252 that stores the sentences (the document data for training 3121) registering the words relevant to the candidate column 21251, a label column 21253 that stores information (“T”, “F”, and “Null”) to specify the labels provided to the words relevant to the candidate column 21251, a relation with positive example column 21254, and a relation with negative example column 21255.

The relation with positive example column 21254 includes an overlap sub-column 21254a that stores a feature (hereinafter referred to as a positive example overlapping feature) shared with a word of the positive example registered with the supervised dictionary data 2122 among the feature quantities provided to the words relevant to the candidate column 21251, and a difference sub-column 21254b that stores a feature (hereinafter referred to as a positive example differential feature) not provided to such a word of the positive example registered with the supervised dictionary data 2122 among the feature quantities provided to the words relevant to the candidate column 21251. In the meantime, the relation with negative example column 21255 includes an overlap sub-column 21255a that stores a feature (hereinafter referred to as a negative example overlapping feature) shared with a word of the negative example registered with the supervised dictionary data 2122 among the feature quantities provided to the words relevant to the candidate column 21251, and a difference sub-column 21255b that stores a feature (hereinafter referred to as a negative example differential feature) not provided to such a word of the negative example registered with the supervised dictionary data 2122 among the feature quantities provided to the words relevant to the candidate column 21251.

In the example of FIG. 8, the word “sasaki” is provided with the label “T”, has “run” as the positive example overlapping feature, and has “purchase” as the negative example differential feature.

Next, the check label data will be described.

<Check Label Data>

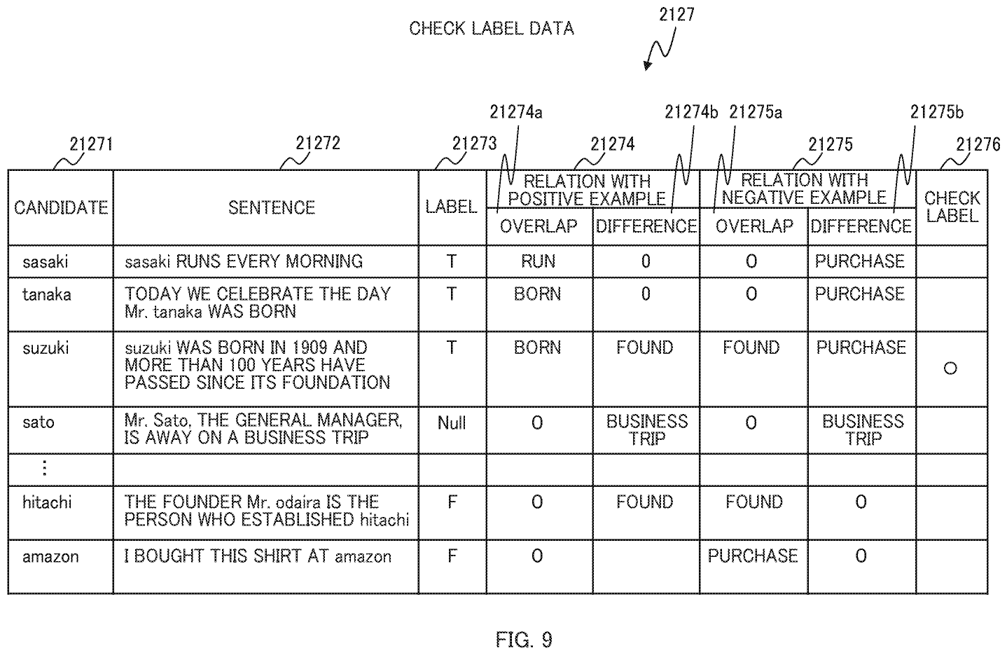

FIG. 9 is a diagram showing an example of the check label data 2127. The check label data 2127 includes a candidate column 21271, a sentence column 21272, a label column 21273, an overlap/difference relative to positive example column 21274, an overlap/difference relative to negative example column 21275, and a check label column 21276.

Among them, the candidate column 21271, the sentence column 21272, the label column 21273, the overlap/difference relative to positive example column 21274, and the overlap/difference relative to negative example column 21275 are similar to those in the feature difference data 2125. The check label column 21276 stores information (a check label) indicating the result of determination concerning the validity of setting of the label to each word relevant to the candidate column 21271. For example, if the validity of setting of the label to a certain word is questionable, then a value “∘” is stored in the corresponding place in the check label column 21276.

Next, the feedback part 2113 shown in FIG. 2 accepts from the user a correction of the inference model 200 created by the learning part 2111 based on the information (the check label) indicating the content of the determination by the evaluation part 2112.

Specifically, the feedback part 2113 accepts from the user a correction of the weight value specified by the learning part 2111.

The inference part 2114 accepts an inference request including the document data for inference 3122 from one of the terminals 3, and sets the label to the word in the sentence indicated in the document data for inference 3122 (performs inference on the word relevant to the personal name) by using the inference model 200, thereby analyzing the semantic contents of the sentence relevant to the actual document data 3122. Meanwhile, the inference part 2114 registers this result with the inference result data 2124.

The above-described functions of the analysis node 2 are realized either by hardware of the analysis node 2 or by causing the processing unit 21 of the analysis node 2 to read and execute programs stored in the memory 22 or the disk device 27. Moreover, these programs are stored in a storage device such as a secondary storage device, a non-volatile semiconductor memory, a hard disk drive, and an SSD, or in a non-transitory data storage medium readable with an information processing apparatus, such as an IC card, an SD card, and a DVD.

<<Processing>>

Next, a description will be given of document analysis processing to be performed by the document analysis system 100 for analyzing the document data for inference.

<Document Analysis Processing>

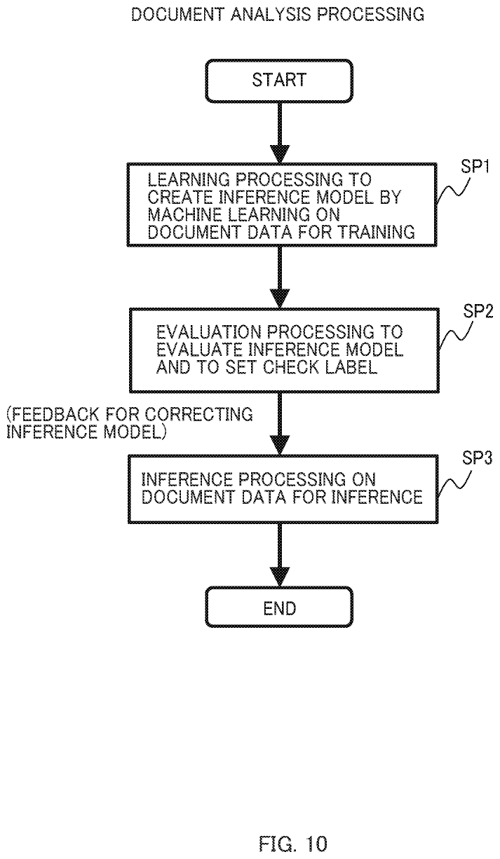

FIG. 10 is a flowchart to explain an example of the document analysis processing. First, the analysis node 2 executes the learning processing by performing prescribed machine learning on each word in the sentence of document data for training, and thus creating the inference model 200 that infers the label corresponding to the inputted word (SP1). Then, the analysis node 2 executes evaluation processing to evaluate the validity of setting of the label in accordance with the created inference model 200 and to set the check label (SP2). Here, the analysis node 2 accepts from the user the correction (feedback) of the inference model 200 based on the check label set in the course of the evaluation processing. The analysis node 2 executes inference processing to infer the label corresponding to each word in the document data for inference based on the corrected inference model 200 and on the label (SP3).

Now, details of each processing will be described.

<Learning Processing>

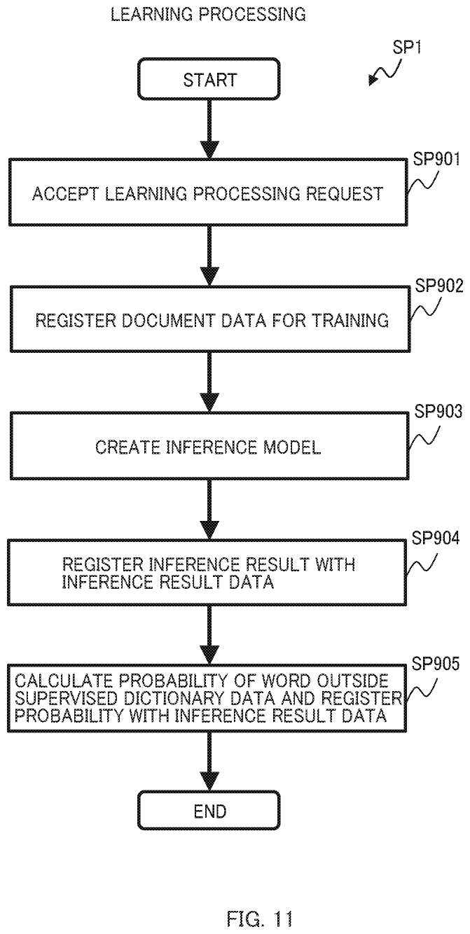

FIG. 11 is a flowchart to explain an example of the learning processing. First, the learning part 2111 of the analysis node 2 accepts a learning processing request from the user (SP901). Specifically, the analysis node 2 receives the document data for training 3121 and the supervised dictionary data 2122 from one of the terminals 3, for example.

The learning part 2111 registers the received document data for training 3121 with the document data 2121 (SP902). Meanwhile, the learning part 2111 registers the supervised dictionary data 2122 (SP903).

The learning part 2111 creates the inference model 200 by the machine learning based on the supervised dictionary data 2122 and the document data 2121 (S903). The learning part 2111 registers a result of creation with the inference result data 2124 (SP904).

Specifically, the learning part 2111 extracts all the words registered with the supervised dictionary data 2122 (hereinafter referred to as candidate words) from the respective sentences registered with the document data for training 3121, for example. Then, the learning part 2111 extracts each of the words (other words in the document data for training 3121) that appears at a predetermined frequency or more often in a predetermined range around each candidate word thus extracted as the positive feature (to be more precise, sets a positive value to the weight value of the feature) by way of the machine learning. In the meantime, the learning part 2111 extracts each of the words (other words in the document data for training 3121) that appears less often than the predetermined frequency in the predetermined range around each candidate word thus extracted as the negative feature (to be more precise, sets a negative value to the weight value of the feature) by way of the machine learning. Note that this method is disclosed in “Ce Zhang, “DeepDive: A Data Management System for Automatic Knowledge Base Construction,” Doctoral dissertation of University of Wisconsin-Madison, March 2015”, for example.

To be more precise, the learning part 2111 discovers the candidate words (the positive examples) “sasaki” and “tanaka” registered with the positive example table 21221 in the supervised dictionary data 2122 in sentences “Mr. sasaki runs every morning” and “today we celebrate the day Mr. tanaka was born” in the document data for training 3121, for example. Then, the learning part 2111 extracts the words “run” and “born” located near “sasaki” and “tanaka” as the positive feature quantities related to “sasaki” and “tanaka”, respectively. In the meantime, the learning part 2111 discovers the candidate words (the negative examples) “hitachi” and “amazon” registered with the negative example table 21222 in the supervised dictionary data 2122 in sentences “the founder Mr. odaira is the person who established hitachi” and “I purchased this shirt at amazon” in the document data for training 3121. Then, the learning part 2111 extracts the word “found” not located near “hitachi” as the negative feature related to “hitachi”, which appears less often near a personal name.

As described above, the learning part 2111 performs specification of the feature quantities regarding all combinations of every word in the supervised dictionary data 2122 and every sentence in the document data for training 3121, thereby automatically creating the inference model 200 including the probability calculation formula 201. Here, the contents of the inference model 200 are registered with the inference model parameter 2123.

For instance, the probability calculation formula 201 is defined as follows:

Probability P=w1*“run”+w2*“born”+w3*“found”+ . . . ;

First threshold=0.85; and

Second threshold=0.25.

Here, the values w1, w2, and w3 are the weight values relevant to the feature quantities. By creating the inference model 200 as described above through the machine learning, the weight values relevant to the respective feature quantities are determined. For example, a positive value is set to the weight value w2 relevant to the feature (such as “born”) that often appears near a personal name word from a statistical perspective. On the other hand, a negative value is set to the weight value w3 relevant to the feature (such as “found”) that does not often appear near a personal name word from a statistical perspective.

Next, the analysis node 2 inputs a given piece of data (an additional word in the document data for training) to the inference model 200, which has not previously been registered with the supervised dictionary data 2122. Hence, the analysis node 2 specifies a feature of the additional word in the document data for training, calculates the probability P of the additional word in the document data for training, and sets the corresponding label (SP905). In this way, the analysis node 2 completes the inference model 200. Here, any of the words that has been learned in the learning processing may be reused instead of the additional word in the document data for training.

For example, the analysis node 2 inputs a word “suzuki” to the inference model 200. Hence, the analysis node 2 calculates its probability P and registers the value of the probability P (“0.88”, for example) with the probability column 21246 in the inference result data 2124. Since this probability P is larger than the first threshold, the analysis node 2 registers a label “T” representing a high probability of the word “suzuki” being a personal name with the label column 21245 in the inference result data 2124. Meanwhile, regarding another word having the calculated probability P below the second threshold, the analysis node 2 registers a label “F” representing a low probability of this word being a personal name with the label column 21245. In the meantime, regarding still another word having the calculated probability P below the first threshold but equal to or above the second threshold, the analysis node 2 registers a label “Null” representing an uncertainty as to whether or not the word represents a personal name with the label column 21245. Hence the learning processing is terminated.

Next, details of the evaluation processing to evaluate the created inference model 200 will be described.

<Evaluation Processing>

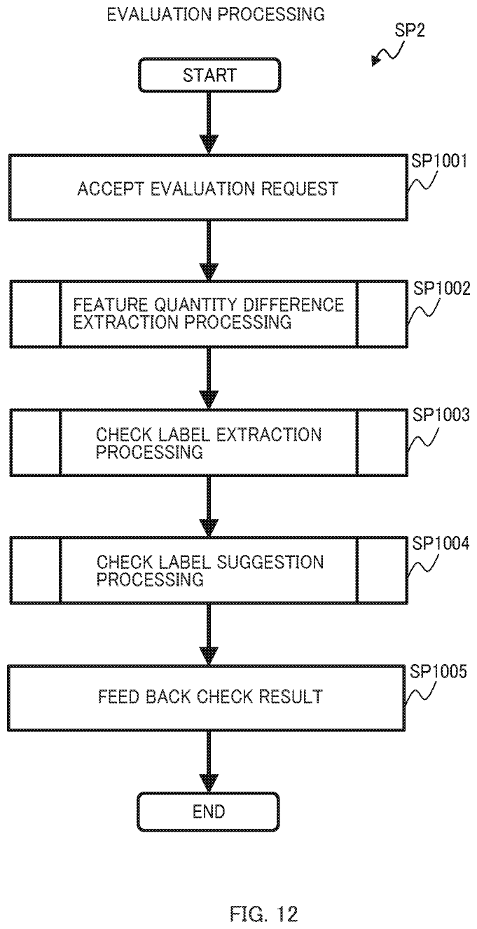

FIG. 12 is a flowchart to explain details of the evaluation processing. First, the evaluation part 2112 of the analysis node 2 accepts an evaluation processing request from the user (SP1001). Specifically, the evaluation part 2112 accepts a prescribed input from one of the terminal 3, for example.

Upon acceptance of the evaluation processing request, the analysis node 2 executes feature difference extraction processing to compare the feature of each word specified in the course of the learning processing with the feature obtained by inputting the given piece of data to the inference model 200 created as a consequence of the learning processing (SP1002). Then, the analysis node 2 executes check label extraction processing to set the check label to a word that satisfies a prescribed condition based on a result of the feature difference extraction processing (SP1003). Details of each processing will be described later.

The analysis node 2 executes check label suggestion processing to display a check label suggestion screen that displays the check label set up by the check label extraction processing, and accepting a given instruction from the user (SP1004). Details of the check label suggestion processing will be described later.

The analysis node 2 executes feedback processing to input the accepted instruction either to the inference model 200 or to the inference result data 2124 (SP1005). Hence the evaluation processing is terminated.

Now, details of the feature difference extraction processing will be described.

<Feature Difference Extraction Processing>

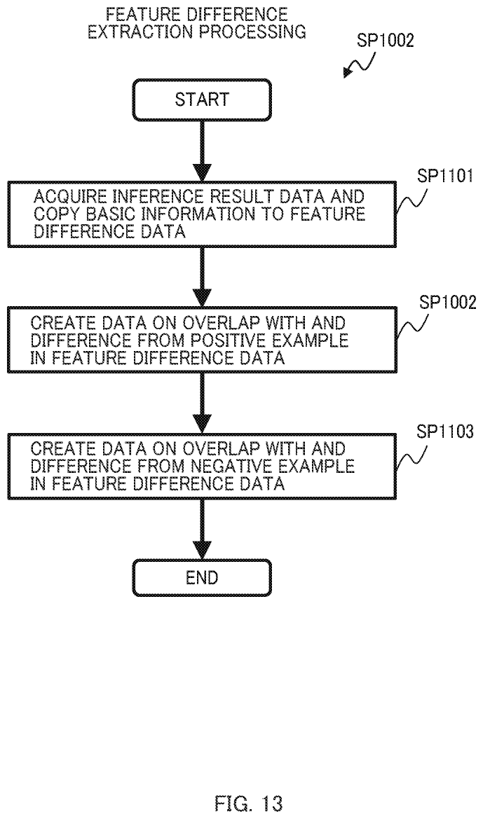

FIG. 13 is a flowchart to explain details of the feature difference extraction processing. First, the evaluation part 2112 of the analysis node 2 creates a new record in the feature difference data 2125, and copies the values in the candidate column 21241, the sentence column 21243, and the label column 21245 in the inference result data 2124 to the candidate column 21251, the sentence column 21252, and the label column 21253 in the created record, respectively (SP1101).

Next, the evaluation part 2112 registers information, which concerns either a difference or an overlap between the feature of each word determined to be the positive example in the course of the learning processing and a feature of a given word specified as a consequence of inputting the word to the inference model 200, with the feature difference data 2125 (SP1102).

Specifically, the evaluation part 2112 first registers information concerning the feature quantities possessed by the words of the positive example with the feature difference data 2125. To be more precise, the evaluation part 2112 specifies all the feature quantities of the words having the value “positive” in the supervised flag column 21242 and the value “t” in the feature column 21244 of their records out of the inference result data 2124, and registers the respective feature quantities thus specified with the overlap sub-column 21254a of the relation with positive example column 21254 for the respective records in the feature difference data 2125.

In the meantime, the evaluation part 2112 registers information concerning the feature quantities not possessed by the words of the positive example with the feature difference data 2125. To be more precise, the evaluation part 2112 specifies all the feature quantities of the words having the value “positive” in the supervised flag column 21242 but no registered values in the feature column 21244 of their records out of the inference result data 2124, and registers the respective feature quantities thus specified with the difference sub-column 21254b of the relation with positive example column 21254 for the respective records in the feature difference data 2125.

Next, the evaluation part 2112 registers information concerning the feature quantities possessed by the words of the negative example with the feature difference data 2125 (SP1103).

Specifically, the evaluation part 2112 first registers information concerning the feature quantities possessed by the words of the negative example with the feature difference data 2125. To be more precise, the evaluation part 2112 specifies all the feature quantities of the words having the value “negative” in the supervised flag column 21242 and the value “t” in the feature column 21244 of their records out of the inference result data 2124, and registers the respective feature quantities thus specified with the overlap sub-column 21255a of the relation with negative example column 21255 for the respective records in the feature difference data 2125.

In the meantime, the evaluation part 2112 registers information concerning the feature quantities not possessed by the words of the negative example with the feature difference data 2125. To be more precise, the evaluation part 2112 specifies all the feature quantities of the words having the value “negative” in the supervised flag column 21242 but no registered values in the feature column 21244 of their records out of the inference result data 2124, and registers the respective feature quantities thus specified with the difference sub-column 21255b of the relation with negative example column 21255 for the respective records in the feature difference data 2125.

As described above, the analysis node 2 specifies the overlapping feature quantities (positive example overlapping feature quantities and negative example overlapping feature quantities) and the differential feature quantities (positive example differential feature quantities and negative example differential feature quantities). Hence the feature difference extraction processing is terminated.

Next, details of the check label extraction processing will be described.

<Check Label Extraction Processing>

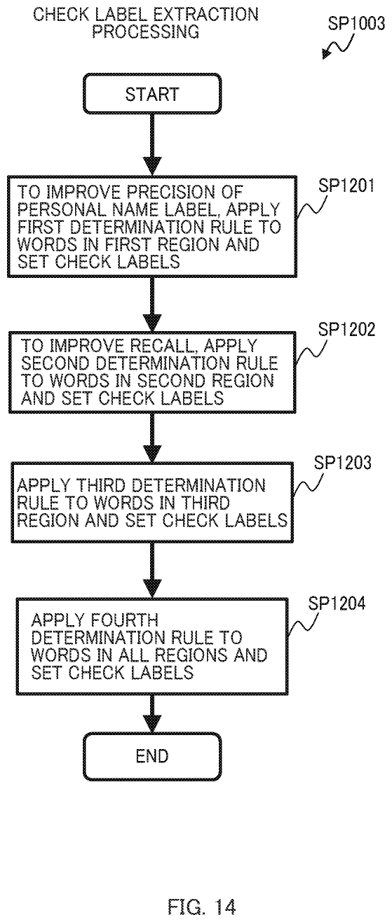

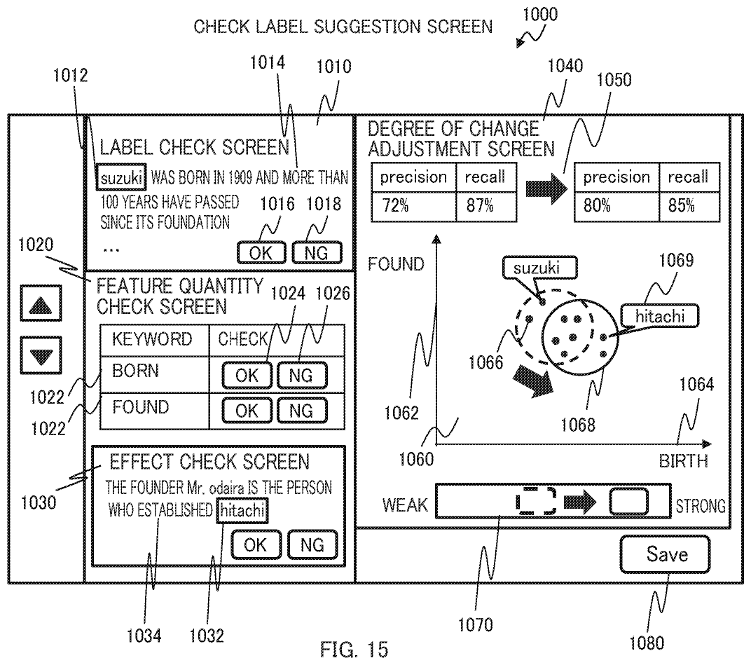

FIG. 14 is a flowchart to explain details of the check label extraction processing. The evaluation part 2112 of the analysis node 2 determines whether or not it is appropriate to set the check label to each of the words.

First, the evaluation part 2112 determines validity of setting of the label to each word by applying the first determination rule, and corrects the label as appropriate (SP1201). To be more precise, when a word that belongs to the first region satisfies the first determination rule, the evaluation part 2112 changes the label for this word from “T” to “F”. Application of the first determination rule makes it possible to remove an erroneous label if such a label is attached by mistake to a word which does not mean a personal name.

Specifically, the evaluation part 2112 first acquires words each having the probability P in the first region and the content of the first determination rule. To be more precise, the evaluation part 2112 specifies all the words having the value of the probability column 21246 in the inference result data 2124 equal to or above the first threshold out of the words in the feature difference data 2125, and acquires the contents in the label operation column 21262 and the rule column 21264 of the records with the value “1” stored in the region column 21263 of the check label extraction rule 2126, for example.

Then, regarding the feature of each of the specified words, the evaluation part 2112 determines whether or not the probability P of the word is equal to or above the first threshold (focuses on the “difference from the positive example”) because the weight of the positive example differential feature is smaller than the weight of the positive example overlapping feature beyond necessity. Then, the evaluation part 2112 sets the check label to the word which is so determined.

To be more precise, the evaluation part 2112 specifies all the records in the check label data 2127, the records including the words each having the probability P equal to or above the first threshold and being registered with the candidate column 21271, and specifies all the feature quantities of the respective records registered with a difference sub-column 21274b of the overlap/difference relative to positive example column 21274, for example. Then, the evaluation part 2112 specifies the feature among the specified feature quantities which has the smallest weight value by referring to the inference model parameter 2123, and sets up (registers “∘” to) the check label column 21276 of the record in the check label data 2127, in which the word having the specified feature is registered with the candidate column 21271 thereof.

Next, the evaluation part 2112 determines validity of setting of the label to each word by applying the second determination rule, and corrects the label as appropriate (SP1202). To be more precise, when a word having the probability P that belongs to the second region satisfies the second determination rule, the evaluation part 2112 changes the label for this word from “Null” to “T”. Application of the second determination rule makes it possible to attach an appropriate label to the word if no label is attached thereto by mistake even though the word means a personal name.

Specifically, the evaluation part 2112 first acquires words each having the probability P in the second region and the content of the second determination rule. To be more precise, the evaluation part 2112 specifies all the words that represent the contents in the candidate column 21241 of the records in which the probability P below the first threshold but equal to or above the second threshold is stored in the probability column 21246 out of the respective words in the inference result data 2124, for example. Moreover, the evaluation part 2112 acquires the contents in the label operation column 21262 and the rule column 21264 of the records with the value “2” stored in the region column 21263 of the check label extraction rule 2126.

Then, regarding the feature of each of the specified words, the evaluation part 2112 determines whether or not the probability P of the word is below the first threshold (focuses on the “difference from the negative example”) because the word has the positive example overlapping feature but its weight is small. Then, the evaluation part 2112 sets the check label to the word which is so determined.

To be more precise, the evaluation part 2112 specifies all the feature quantities registered with a difference sub-column 21275b of the overlap/difference relative to negative example column 21275 of the records in the check label data 2127, which have the words each having the probability P below the first threshold but equal to or above the second threshold and being registered with the candidate column 21271. Then, the evaluation part 2112 specifies the feature among the specified feature quantities which has the largest weight value by referring to the inference model parameter 2123, and sets up (registers “∘” to) the check label column 21276 of the record in the check label data 2127, in which the word having the specified feature is registered with the candidate column 21271 thereof.

Next, the evaluation part 2112 determines validity of setting of the label to each word by applying the third determination rule, and corrects the label as appropriate (SP1203). To be more precise, when a word having the probability P that belongs to the third region satisfies the third determination rule, the evaluation part 2112 changes the label for this word from “F” to “T”. Application of the third determination rule makes it possible to attach an appropriate label to the word if no label is attached thereto by mistake even though the word means a personal name.

Specifically, the evaluation part 2112 first acquires words each having the probability P in the third region and the content of the third determination rule. To be more precise, the evaluation part 2112 specifies all the words each having the value below the second threshold in the probability column 21246 of the inference result data 2124 out of the respective words in the feature difference data 2125. Moreover, the evaluation part 2112 acquires the contents in the label operation column 21262 and the rule column 21264 of the records with the value “3” stored in the region column 21263 of the check label extraction rule 2126.

Then, regarding the feature of each of the specified words, the evaluation part 2112 determines whether or not the probability P of the word is below the second threshold (focuses on the “difference from the negative example”) because the word has the negative example differential feature with its weight being smaller than the weight of the negative example overlapping feature. Then, the evaluation part 2112 sets the check label to the word which is so determined.

To be more precise, the evaluation part 2112 specifies all the records in the check label data 2127, which are the records including the words each having the probability P below the second threshold and being registered with the candidate column 21271, and specifies all the feature quantities of the respective records registered with a difference sub-column 21275b of the overlap/difference relative to negative example column 21275. Then, the evaluation part 2112 specifies the feature among the specified feature quantities which has the largest weight value by referring to the inference model parameter 2123, and sets up (registers “∘” to) the check label column 21276 of the record in the check label data 2127, in which the word having the specified feature is registered with the candidate column 21271 thereof.

Lastly, the evaluation part 2112 determines validity of setting of the label to each word by applying the fourth determination rule, and corrects the label as appropriate (SP1204). To be more precise, regarding all the words (the words in all the regions), the evaluation part 2112 changes the label of the word having the current label of “T” into the label “F” or changes the label of the word having the current label of “F” into the label “T” in the case where the word satisfies the fourth determination rule. Application of the fourth determination rule makes it possible to attach an appropriate label to the word in a case where no label is attached thereto by mistake even though the word means a personal name, or in an opposite case thereto.

Specifically, the evaluation part 2112 first acquires the words in all the regions and the content of the fourth determination rule. The evaluation part 2112 specifies all the words in the feature difference data 2125 and acquires the contents in the label operation column 21262 and the rule column 21264 of the records with the value “4” stored in the region column 21263 of the check label extraction rule 2126.

Then, regarding each of the specified words, the evaluation part 2112 determines whether or not there is another word (a word of the positive example or a word of the negative example learned already) that has the same feature but a different label is set thereto (focuses on the content of the label). Then, the evaluation part 2112 sets the check label to the word which is so determined.

To be more precise, the evaluation part 2112 refers to the respective records in the check label data 2127, thereby specifying two words that share a list of the feature quantities registered with an overlap sub-column 21274a of the overlap/difference relative to positive example column 21274 but have different labels registered with the label column 21273 (one of the labels is “T” and the other label is “F”), for example. Then, the evaluation part 2112 sets up (registers “∘” to) the check label column 21276 of each of the records in which the specified words are registered with the candidate column 21271 thereof. Hence the check label extraction processing is terminated.

As described above, each region is assumed to have one determination rule in this embodiment. However, each region may have two or more determination rules. Meanwhile, in this embodiment, the feature of each word is compared with any one of the feature of the word of the “positive example” and the feature of the word of the “negative example”. Nonetheless, any of the determination rules may combine a distance between the feature of the word of the “positive example” and the feature of the word of the “negative example”, like in a case of selecting a word having the smallest difference from the feature of the word of the “positive example” and having the largest difference from the feature of the word of the “negative example”, for example.

In the meantime, the overlapping feature and the differential feature are used as the features to be applied to the determination rules in this embodiment. Here, any of the determination rules may be based on the values of the features instead, like in a case of selecting one of the feature quantities having the smallest difference from the feature of the word of the positive example, which is the one that has the largest weight value, for instance.

Furthermore, the numbers of the feature quantities are used as the determination rules in this embodiment. Instead, a determination using a variation in probability P of the same word may be defined, such as “if the same word is extracted as different words (such as “suzuki”) which have the values of the probability P that are significantly different from each other, then a check label is set to these words because it is highly likely that a personal name and a corporate name are mixed together therein”.

<Check Label Suggestion Processing>

Next, details of the check label suggestion processing will be described. A check label suggestion screen indicating a setting status of the check label is displayed in the check label suggestion processing.

FIG. 15 is a diagram showing an example of the check label suggestion screen. A check label suggestion screen 1000 is a screen that displays information on a word (hereinafter referred to as a check word) subjected to the setting of the check label (that is, information on the record in which “o” is registered with the check label column 21276 in the check label data 2127).

The check label suggestion screen 1000 includes a label check screen 1010 provided with a word display column 1012 that displays the check word (the candidate column 21271) and a sentence display column 1014 that displays the sentence (the sentence column 21272) containing the check word. Meanwhile, the label check screen 1010 is also provided with an OK button 1016 to be selected by the user when the check word represents a personal name and an NG button 1018 to be selected by the user when the check word does not represent a personal name. The value “T” is set to the label relevant to the check word when the OK button 1016 is selected, and the value “F” is set to the label relevant to the check word when the NG button 1018 is selected. In this way, the user can correct the label according to the inference model 200.

Meanwhile, the check label suggestion screen 1000 includes a feature check screen 1020. The feature check screen 1020 is displayed when the NG button 1018 on the label check screen 1010 is selected. The feature check screen 1020 is provided with feature list display columns 1022 each of which displays the feature possessed by the check word (that is, the word having the value “t” registered with the feature column 21244 of the record relevant to the check word in the inference result data 2124).

Each feature list display column 1022 includes an OK button 1024 to be selected by the user when the feature displayed in the column is appropriate as a word for determining a personal name, and an NG button 1026 to be selected by the user when the feature displayed in the column is not appropriate as a word for determining a personal name. When the NG button 1026 is selected, the user can correct the corresponding feature or a parameter related thereto through a prescribed editing screen (not shown). For example, it is possible to delete a record relevant to the feature corresponding to the inference model parameter 2123 or to change the value in the value column 21232 (to reduce the value, for instance). Meanwhile, it is possible to set a value other than the value “t” to the feature column 21244 of the record relevant to the check word in the inference result data 2124. In this way, the contents in the inference model 200 can be corrected properly.

Moreover, the check label suggestion screen 1000 includes an effect check screen 1030. The effect check screen 1030 includes an other word display column 1032 that displays another word which is subject to a change in feature when the feature or the parameter related thereto is corrected as a result of selecting the NG button 1026 in one of the feature list display columns 1022, and a sentence display column 1034 that displays the sentence containing the word relevant to the other word display column 1032. Specifically, the effect check screen 1030 displays the word (the candidate column 21241) being searched from the inference result data 2124 and having the feature that undergoes the selection of the corresponding NG button 1026, and the content of the sentence (the sentence column 21243) containing that word.

By using the feature check screen 1020 and the effect check screen 1030 described above, the user can correct a result of inference by an operation similar to that to be carried out on the label check screen 1010. Moreover, the user can determine the feature for adjusting the weight of the inference model parameter 2123 based on the result.

Furthermore, the check label suggestion screen 1000 includes a degree of change adjustment screen 1040. The degree of change adjustment screen 1040 is provided with a precision change display screen 1050, a label attachment region display screen 1060, a slide bar 1070 for adjusting the weight of the feature, and a save button 1080.

The precision change display screen 1050 displays changes in precision parameters (precision, recall) before and after the adjustment of the weight of the feature.

The label attachment region display screen 1060 displays a two-dimensional graph that depicts a relation between the feature quantities possessed by the words and the labels to be attached to the words. Specifically, a vertical axis 1062 and a horizontal axis 1064 of the graph indicate the feature quantities displayed on the feature check screen 1020, respectively. Dots 1066 on the graph represent the words. When a dot 1066 is located inside a circle 1068 displayed on the graph, a label is attached to the word corresponding to that dot 1066. When another dot 1066 is located outside the circle 1068 displayed on the graph, no label is attached to the word corresponding to that dot 1066. In the meantime, each dot 1066 is provided with a word column 1069 corresponding to that dot 1066.

Note that when any of the words has two or more feature quantities, each axis of the two-dimensional graph on the label attachment region display screen 1060 may be depicted as an axis after being subjected to map transformation processing so that the feature quantities can be compressed and converted into a coordinate on the two-dimensional graph.

The slide bar 1070 accepts a change in weight value of each feature (the value column 21232 in the inference model parameter 2123) from the user. When the weight value is changed by using the slide bar 1070, the label (such as the label “F”) is attached to the relevant word depending on an amount of adjustment of the weight value, or a label (such as the label “T”) is newly attached to the word. The user can check the changed content on the label attachment region display screen 1060.

The save button 1080 accepts the setting of the current weight value set by using the slide bar 1070 to the value column 21232 in the inference model parameter 2123. The document analysis system 100 can create a new inference model by performing the machine learning again based on the corrected weight value.

Next, details of the inference processing will be described.

<Inference Processing>

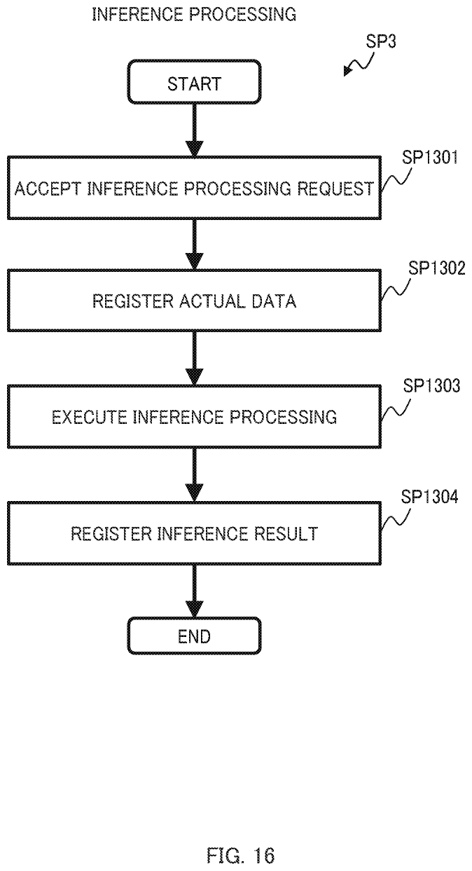

FIG. 16 is a flowchart to explain details of the inference processing. First, the inference part 2114 of the analysis node 2 accepts the inference request from the user (SP1301). Specifically, the inference part 2114 receives the document data for inference 3122 from one of the terminals 3, for example.

The inference part 2114 registers the received document data for inference 3122 with the document data 2121 (SP1302). Then, the inference part 2114 performs analyses of the words and the sentences regarding the respective words in the sentences recorded in the document data for inference 3122 based on the inference model 200 (the inference model parameter 2123) subjected to the correction of the labels by use of the check labels and the like in the evaluation processing (SP1303). Thereafter, the inference part 2114 registers data obtained by the analyses of the words with the inference result data 2124 (SP1304). Hence the inference processing is terminated.

As described above, the document analysis system 100 of this embodiment creates the inference model 200 to infer the labels (such as “T”, “F”, and “Null”) to be set to the input data by performing the machine learning for specifying the feature quantities regarding the respective pieces of the document data for training (words). Then, the document analysis system 100 determines the validity of inference of each label according to the inference model 200 by determining the similarity between the feature of each piece of the document data for training specified by the machine learning and the feature of the given piece of data (the additional word in the document data for training) specified by inputting the additional word in the document data for training to the created inference model 200. Thereafter, the document analysis system 100 outputs the information (the check labels) indicating the contents of the determination. This enables the user to determine whether or not the inference model 200 is supposed to be corrected. Thus, it is possible to reliably improve precision of the inference model 200 created by the machine learning.

In other words, the document analysis system 100 of this embodiment verifies the inference model 200 by comparing a feature of supervised data and a feature according to an inference model with each other in light of a similarity. Accordingly, even when the user has little knowledge about determination of appropriateness of the supervised data and appropriateness of the inference by the inference model 200, the user can correct the inference model 200 and improve its precision easily. That is to say, the document analysis system 100 enables a user without analytical knowledge to tune the inference model 200 with less man-hours.

While the embodiment of the present invention has been described above, the present invention is not limited only to the embodiment described as an example but various changes are possible within the range not departing from the gist of the invention.

For example, the personal names are used as attributes of the data subject to setting of the labels. However, other attributes may be used as the targets instead.

Meanwhile, the respective functions described in the embodiment may be constructed by using a single program or divided into portions of two or more programs. In the meantime, these programs may be installed on either the analysis node 2 or any of the terminals 3. Alternatively, the programs may be installed on another information processing apparatus.

At least the following features are clarified by the description of this specification. Specifically, the inference model may infer the label from the feature of the input data based on the probability serving as a parameter used to determine the type of the label to be set to the input data. Meanwhile, the model creation supporting system may set determination rules in the evaluation processing in order to determine the similarity between the feature quantities depending on the probability, and may determine the validity of inference of the label in accordance with the inference model based on the set determination rules.

Thus, it is possible to perform accurate determination depending on the type of the label by determining the validity of inference of the label based on the determination rules to determine the similarity between the feature quantities depending on the probability serving as the parameter used to determine the type of the label.

Meanwhile, the model creation supporting system may determine the validity of inference of the label in the evaluation processing by determining similarity between the feature of the given piece of data and the feature of the piece of document data for training while specifying a feature shared by the two pieces of data and a feature possessed only by one of the pieces of data.

As described above, the validity of inference of the label can be accurately determined by specifying a common point (the overlap) and a different point (the difference) between the feature quantities that form the basis of setting the label in the case of determination of the validity of inference of the label. Specifically, it is possible to determine accuracy of the inference model 200 by using information on the distance between the feature quantities of the supervised data and of output data (data coming out of the inference model 200).

In the meantime, the model creation supporting system may execute feedback processing to accept a correction of the created inference model from a user based on information indicating the content of the determination.

The execution of the feedback by accepting the correction of the created inference model 200 from the user makes it possible to improve the inference model 200 and to increase reliability thereof, for example.

Meanwhile, the model creation supporting system may create the inference model in the learning processing by performing machine learning so as to specify weight values of the feature quantities, the inference model being designed to infer the label to be set to the piece of input data based on a weight value of the feature of the piece of input data. Moreover, the model creation supporting system may determine validity of the weight value in the inference model by determining a similarity between the weight value of the feature of the given piece of data and the weight value of the feature of one of the pieces of document data for training, and may accept a correction of the specified weight value from the user in the feedback processing.

As described above, in the inference model 200 configured to infer the label to be set to the piece of input data based on the weight value of the feature of the piece of input data, the similarity between the weight value of the feature of the given piece of data (the additional word in the document data for training) and the weight value of the feature of a certain piece of the document data for training, and the correction of the weight value from the user is accepted. Thus, it is possible to perform detailed tuning of the inference model 200 and to further increase the reliability of the inference model 200.

What is claimed is:

1. A model creation supporting method comprising:
causing a model creation supporting system provided with a processor and a memory to execute
learning processing to create an inference model by performing machine learning on a plurality of pieces of training data so as to specify a feature of each piece of the data, the inference model being designed to infer a label to be set to a piece of input data based on a feature of the piece of input data, and
evaluation processing to determine validity of inference of the label in accordance with the inference model by determining a similarity between a feature of a given piece of data specified by inputting the given piece of data to the created inference model and the feature of one of the pieces of training data specified by the machine learning, and to output information indicating a content of the determination.

2. The model creation supporting method according to claim 1, wherein
the inference model infers the label from the feature of the piece of input data based on a probability serving as a parameter used to determine a type of the label to be set to the piece of input data, and
in the evaluation processing, the model creation supporting system sets a plurality of determination rules to determine the similarity between the feature quantities depending on the probability, and determines the validity of inference of the label in accordance with the inference model based on the set determination rules.

3. The model creation supporting method according to claim 1, wherein the model creation supporting system determines the validity of inference of the label in the evaluation processing by determining the similarity between the feature of the given piece of data and the feature of the piece of training data while specifying a feature shared by the two pieces of data and a feature possessed only by one of the pieces of data.

4. The model creation supporting method according to claim 1, further comprising:
causing the model creation supporting system to execute feedback processing to accept a correction of the created inference model from a user based on information indicating the content of the determination.

5. The model creation supporting method according to claim 4, wherein
the model creation supporting system creates the inference model in the learning processing by performing machine learning so as to specify weight values of the feature quantities, the inference model being designed to infer the label to be set to the piece of input data based on a weight value of the feature of the piece of input data, and
the model creation supporting system determines validity of the weight value in the inference model in the evaluation processing by determining a similarity between the weight value of the feature of the given piece of data and the weight value of the feature of one of the pieces of training data, and
the model creation supporting system accepts a correction of the specified weight value from the user in the feedback processing.

6. A model creation supporting system comprising:
a processor;
a memory;
a learning part configured to create an inference model by performing machine learning on a plurality of pieces of training data so as to specify a feature of each piece of the data, the inference model being designed to infer a label to be set to a piece of input data based on a feature of the piece of input data; and
an evaluation part configured to determine validity of inference of the label in accordance with the inference model by determining a similarity between a feature of a given piece of data specified by inputting the given piece of data to the created inference model and the feature of one of the pieces of training data specified by the machine learning, and to output information indicating a content of the determination.

7. The model creation supporting system according to claim 6, wherein
the inference model infers the label from the feature of the piece of input data based on a probability serving as a parameter used to determine a type of the label to be set to the piece of input data, and
the evaluation part sets a plurality of determination rules in order to determine the similarity between the feature quantities depending on the probability, and determines the validity of inference of the label in accordance with the inference model based on the set determination rules.

8. The model creation supporting system according to claim 6, wherein the evaluation part determines the validity of inference of the label in the evaluation processing by determining the similarity between the feature of the given piece of data and the feature of the piece of training data while specifying a feature shared by the two pieces of data and a feature possessed only by one of the pieces of data.

9. The model creation supporting system according to claim 6, further comprising:
a feedback part configured to accept a correction of the created inference model from a user based on information indicating the content of the determination.

10. The model creation supporting system according to claim 9, wherein
the learning part creates the inference model by performing machine learning so as to specify weight values of the feature quantities, the inference model being designed to infer the label to be set to the piece of input data based on a weight value of the feature of the piece of input data, and
the evaluation part determines validity of the weight value in the inference model by determining a similarity between the weight value of the feature of the given piece of data and the weight value of the feature of one of the pieces of training data, and
the feedback part accepts a correction of the specified weight value from the user.
